(19) United States
(12) Patent Application Publication
(10) Pub. No.: US 2011/0227799 A1
(43) Pub. Date: Sep. 22, 2011

(54) ANTENNA AND PORTABLE TERMINAL USING THE SAME

(75) Inventor: Yoshinori HASHIMOTO, Miyazaki (JP)

(73) Assignee: PANASONIC CORPORATION, Osaka (JP)

(21) Appl. No.: 13/038,075

(22) Filed: Mar. 1, 2011

(30) Foreign Application Priority Data
Mar. 17, 2010 (JP) P2010-060617

(51) Int. Cl. H01Q 7/00

(52) U.S. Cl. 343/702; 343/866

(57) ABSTRACT

The present invention aims at providing an antenna that exhibits superior communication performance within a communicable area because an air field within the communicable area is reduced while the communicable area is being expanded, and also providing a portable terminal using the same.

In order to accomplish the objective, the antenna of the present invention includes the followings; namely, a loop antenna having an aperture; a metallic body that opposes the loop antenna and that is electrically insulated from the loop antenna; and a notch that is provided in the metallic body and that is coupled with a periphery of the metallic body, wherein at least a portion of the loop antenna opposes the metallic body, and at least a portion of the notch is covered with the aperture.

### BACKGROUND

1. Field of the Invention

The present invention relates to an antenna for use in RF-ID (Radio Frequency Identification) and NFC (Near Field Communication), as well as to a portable terminal using the same.

2. Description of the Related Art

In recent years, a loop antenna has frequently been used in a portable terminal, like a portable phone and a smart phone, in order to read information from a non-contact IC card and an IC tag and exchange information with a reader/writer.

In general, the loop antenna is smaller than the non-contact IC card, and a magnetic field capture area (a communicable area) is narrow. For these reasons, when the loop antenna reads information from; for instance, a non-contact IC card, difficulty is often encountered in reading information.

Accordingly, in order to expand the communicable area, a combination of the loop antenna with a metallic line is available (see; for instance, JP-2008-28506A).

However, since the communicable area is expanded by use of the metallic line in the related art structure, an air field where the metallic area is absent exists in the vicinity of the expanded area.

For this reason, if a transmission magnetic field originating from the non-contact IC card enters the air field, dielectric electromotive force originating from a magnetic flux from the IC card hardly develops in the loop antenna. As a consequence, even when a communication area is expanded, there is a potential of the loop antenna being unable to establish a communication with the IC card in the air field.

Accordingly, in light of the foregoing problem, the present invention aims at providing an antenna that exhibits superior communication performance win a communicable area while expanding the communicable area as well as a portable terminal using the antenna.

### SUMMARY

In order to solve the problem, the present invention provides an antenna comprising a loop antenna having an aperture; a metallic body that is electrically insulated from the loop antenna and that is placed on one side where the aperture of the loop antenna is provided; and a notch that is smaller than an outer shape of the loop antenna and that is coupled with a periphery of the metallic body, wherein the loop antenna is placed on the metallic body so as to cover the notch.

The present invention makes it possible to provide an antenna that exhibits superior communication performance within a communicable area because an air field in the communicable area is reduced while expanding the communicable area and provide a portable terminal using the antenna.

Another objective of the present invention is to cause an electric current oriented in a direction to cancel an electric current flowing through a loop antenna to flow through the notch, whereby an electric current oriented in the same direction as that of the electric current flowing through the loop antenna flows through the entire metallic body, so that the antenna pattern can be apparently made greater.

Still another objective of the present invention is to make it easy to generate an eddy current flowing through a metallic body, so that more superior communication performance is exhibited within a communicable area.

Yet another objective of the present invention is to let a loop antenna oppose a metallic body without fail, whereby much superior communication performance is exhibited within a communicable area.

Yet another objective of the present invention is to let a loop antenna oppose a metallic body without fail in the greatest area, so that extremely superior communication performance is exhibited within a communicable area.

### BRIEF DESCRIPTION OF THE DRAWINGS

FIG. 1 is an oblique perspective view of an antenna of a first embodiment of the present invention;

FIG. 2 is a top view of the antenna of the first embodiment of the present invention;

FIG. 3 is a side view of the antenna of the first embodiment of the present invention;

FIG. 4 is a view explaining a concept achieved when the antenna of the first embodiment of the present invention emits a magnetic field;

FIG. 5 is a view explaining a concept achieved when the antenna of the first embodiment of the present invention receives a magnetic field;

FIG. 6 is a view showing magnetic field intensity emitted by the antenna of the first embodiment of the present invention;

FIG. 7 is an exploded perspective view of a portable terminal using the antenna of the first embodiment of the present invention;

FIG. 8 is an oblique perspective view of the antenna of a second embodiment of the present invention;

FIG. 9 is a plan view of the antenna of the second embodiment of the present invention;

FIG. 10 is a side view of the antenna of the second embodiment of the present invention;

FIG. 11 is a view for explaining a concept achieved when the antenna of the second embodiment of the present invention emits a magnetic field;

FIG. 12 is a view explaining a concept achieved when the antenna of the second embodiment of the present invention receives a magnetic field;

FIG. 13 is a view showing magnetic field intensity emitted by the antenna of the second embodiment of the present invention;

FIG. 14 is an exploded perspective view of a portable terminal using the antenna of the second embodiment of the present invention; and

FIG. 15 is a view showing magnetic field intensity emitted by another antenna of the second embodiment of the present invention.

### DETAILED DESCRIPTION

An antenna of the present invention includes a loop antenna having an aperture and a metallic body that is electrically insulated from the loop antenna and that is provided on one side where the aperture of the loop antenna is provided. A notch that is smaller than an outer shape of the loop antenna and that is coupled with a periphery of the metallic body is provided on the metallic body. The loop antenna is placed on the metallic body so as to cover the notch.

It thereby becomes possible to reduce an air field within a communicable area while the communicable area is being expanded, so that an antenna exhibiting superior communication performance within a communicable area can be provided.

Further, the notch is substantially identical in size with the aperture of the loop antenna, whereby the antenna can be coupled with the metallic body with superior efficiency, so that electric power induced in the metallic body by an external magnetic field can be transmitted to the antenna with superior efficiency.

The antenna is provided within enclosures, and the metallic body is provided on a back side of one of the enclosures, whereby it is possible to provide a portable terminal that exhibits superior communication performance within a communicable area while the communicable area is being expanded by utilization of the enclosures.

Further, the antenna is provided within the enclosures, and a circuit board provided within the enclosures is used as a metallic body. It thereby becomes possible to provide a portable terminal that exhibits superior communication performance within a communicable area while the communicable area is being expanded by utilization of the circuit board of the portable terminal.

Embodiments of the present invention are hereunder described by reference to the drawings.

### First Embodiment

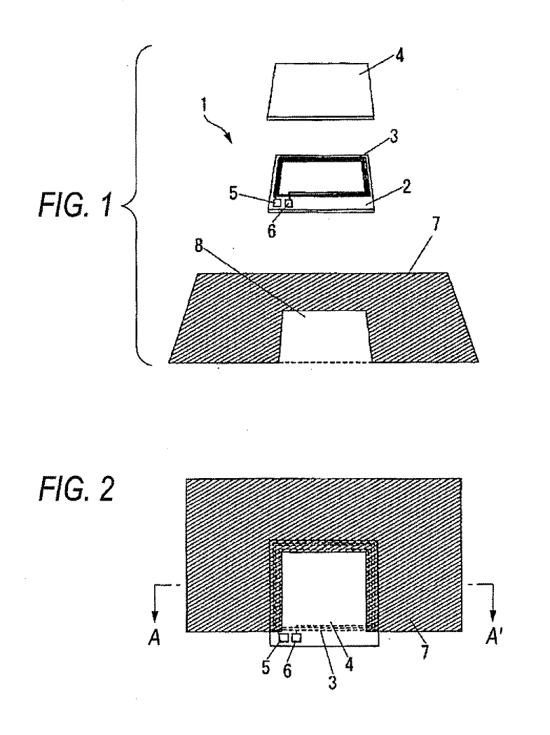

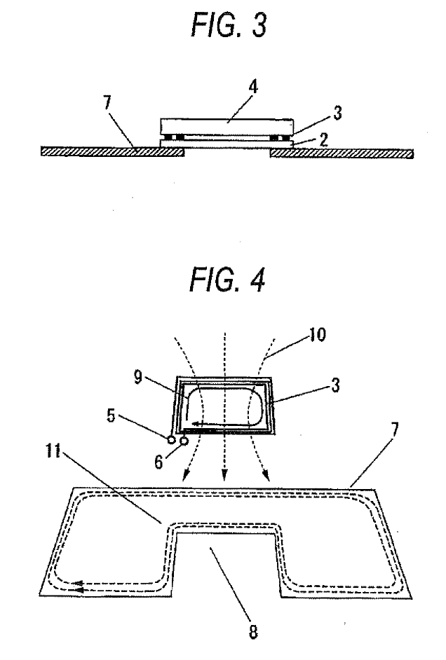

FIG. 1 is an oblique perspective view of an antenna of a first embodiment of the present invention; FIG. 2 is a top view of the antenna of the first embodiment of the present invention; and FIG. 3 is a side view of the antenna of the first embodiment of the present invention. FIG. 3 is a cross sectional view taken along line A-A′ shown in FIG. 2.

The antenna 1 shown in FIG. 1 includes a loop antenna pattern 3 laid on an antenna board 2. In FIG. 1, the antenna pattern 3 exemplifies a three-turn antenna. However, the antenna pattern is not limited to three turns.

In order to lessen influence generated when metal is placed on the antenna, a magnetic sheet 4 is placed on the antenna pattern 3.

The antenna pattern 3 is connected to an input-output terminal of a matching circuit and an input-output terminal of an IC by means of input-output terminals 5 and 6.

A metallic body 7 is provided with a notch 8 that is formed so as to connect with a periphery of the metallic body 7 and that assumes a rectangular shape matching the shape of the antenna. The metallic body 7 is formed into the shape of the letter C by means of the notch 8.

Specifically, the notch 8 is not formed so as to make a hole in the metallic body 7 but assumes a shape cut out of the periphery of the metallic body 7.

The antenna board 2 and the antenna pattern 3 are positioned, while substantially adjoining the metallic body 7, so as to cover the notch 8 of the metallic body 7, and the metallic body 7, the antenna board 2, the antenna pattern 3, and the magnetic sheet 4 are stacked in sequence.

Detailed descriptions are provided to the shape of the antenna pattern 3 and the shape of the notch 8 by reference primarily to FIGS. 2 and 3.

As is obvious from the drawings, the notch 8 is smaller than an outer shape of the antenna pattern 3 (the outermost loop of the antenna pattern 3), and the notch is also formed so as to extend along an aperture (the innermost loop of the antenna pattern 3) of the antenna pattern 3.

Specifically, the notch 8 is made substantially equal in size to the aperture of the antenna pattern 3.

The aperture of the antenna pattern 3 is arranged so as to match the notch 8. As shown in FIG. 2, the antenna pattern 3 is arranged in line with a side of the metallic body 7 where the notch 8 is formed.

As shown in FIG. 3, the antenna pattern 3 is laid on the metallic body 7 by way of the antenna board 2.

The configuration mentioned above makes it possible to efficiently utilize an electric current developing in the metallic body 7, which will be described later.

In the embodiment, the notch 8 is placed so as to situate at the center of the side where the notch is to be formed.

A configuration of the antenna 1 is hereunder described.

First, the antenna board 2 is described. The antenna board 2 is a base board on which electronic members, like the antenna pattern 3, the input-output terminals 5 and 6, and others, are to be mounted. In the embodiment, the essential requirement for the base board is a substrate that exhibits an insulation property. The base board can be formed from; for instance, polyimide, PET, a glass epoxy substrate, and the like.

The antenna pattern 3 is now described. The antenna pattern 3 is formed in a spiral shape. A spiral structure is a spiral shape having an aperture in its center. The spiral structure can assume either a circular shape, a substantial rectangular shape, or a polygonal shape typified by a triangular shape and a square shape. Moreover, the antenna pattern 3 may also be placed in one plane or piled. By adoption of a spiral structure, a magnetic field developing from a reader/writer is caused to effect inter-linkage with the aperture, to thus induce electric power, and it becomes possible to transmit an electric signal to a matching circuit connected to the input-output terminals 5, 6 and an IC chip and to establish communication with the reader/writer. Any material is used as a material for the pattern, so long as the material exhibits electrical conductivity. The material is selected as appropriate from a conductive metallic wire, a metallic plate material, a metallic foil material, and a metallic sleeve material, like gold, silver, copper, aluminum, and nickel. The pattern can be formed from a metallic wire, a metallic foil, a conductive paste, transfer plating, sputtering, deposition, or screen printing.

The magnetic sheet 4 is now described. The magnetic sheet 4 is placed on the antenna pattern 3 and may assume any of a circular shape, a substantially rectangular shape, or a polygonal shape typified by a triangular shape or a square shape. The magnetic sheet 4 is intended for lessening influence which arises when the metallic body is placed on the magnetic sheet 4. It is desirable that the magnetic sheet 4 shall completely cover the antenna pattern 3. So long as the magnetic sheet covers the antenna pattern 3, the magnetic sheet may be larger than the antenna pattern 3. For instance, the magnetic sheet may also be equal in size to the metallic body 7.

Further, either an insulating magnetic material like ferrite or a conductive magnetic material like an electromagnetic steel plate can also be employed as a material for the magnetic body.

The input-output terminals 5 and 6 are now described. The input-output terminals 5 and 6 are electrically connected to the antenna pattern 3. Any material is available, so long as the material exhibits conductivity. The material can be selected as appropriate from a conductive metallic wire, a metallic plate material, a metallic foil material, and a metallic sleeve material, like gold, silver, copper, aluminum, and nickel. The input-output terminals can be formed from a metallic wire, a metallic foil, a conductive paste, transfer plating, sputtering, deposition, or screen printing. The input-output terminals 5 and 6 are electrically connected to a matching circuit and an IC chip. There can be selected a commonly utilized connection technique, such as pin connection, spring connection, soldering, connector connection, and the like.

Any material is used as a material for the input-output terminals, so long as the material exhibits electrical conductivity. The material is selected as appropriate from a conductive metallic foil material and a metallic plate material, like gold, silver, copper, aluminum, and nickel. The input-output terminals can be formed from a metallic foil, a conductive paste, transfer plating, sputtering, deposition, or screen printing.

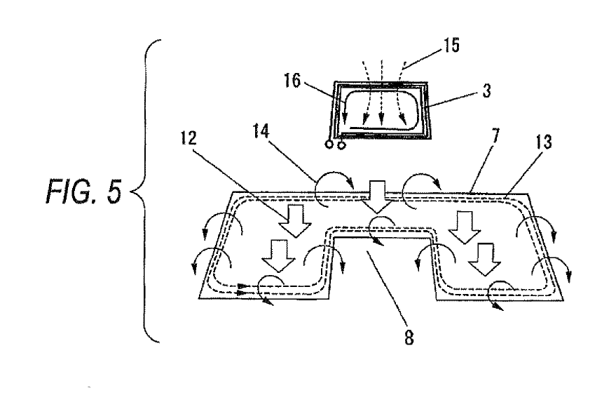

A concept of operation of the antenna of the present invention is now described by reference to FIGS. 4 and 5.

FIG. 4 is a conceptual rendering of the present invention acquired when transmission is performed by means of the antenna. By virtue of signals entered the input-output terminals 5 and 6, an electric current 9 flows into the antenna pattern 3 from an external circuit, whereby a magnetic field 10 develops. An eddy current 11 develops in the metallic body 7 in a direction cancelling the magnetic field 10. As a result of the notch 8 being provided in the metallic body 7 so as to run along the aperture of the antenna pattern 3, the eddy current 11 eventually flows through three sides of the notch in a direction opposite to the electric current 9 flowing through the antenna pattern 3. However, the eddy current 11 flowing through a portion of the metallic body 7 other than the notch 8 is directed in a forward direction with respect to the electric current 9 flowing through the antenna pattern 3. Therefore, the antenna pattern apparently becomes greater, and a degree of coupling with a card that will be on the other end of communication becomes stronger, as a consequence of which communication performance is enhanced.

FIG. 5 is a conceptual rendering of the present invention achieved when the antenna receives a magnetic field from the outside. An eddy current 13 flows along the periphery of the metallic body 7 by means of a magnetic field 12 from the outside, and a magnetic field 14 develops in the periphery of the metallic body 7 because of the eddy current 13. The notch 8 is provided on the metallic body 7 so as to be aligned with the aperture of the antenna pattern 3, whereby the magnetic field 14, such as that shown in FIG. 5, develops in the outer periphery of three sides of the notch 8, and hence a downward magnetic field 15, such as that shown in FIG. 5, develops in an inner periphery of the antenna pattern 3. Although an eddy current 16 develops in the antenna pattern 3 in a direction cancelling the magnetic field 15 at this time, the eddy current 16 is oriented in a forward direction with respect to the eddy current 13 flowing through the periphery of the metallic body 7. Therefore, the antenna pattern apparently becomes greater, and the antenna becomes possible to receive a greater quantity of magnetic field originating from the reader/writer that is to be on the other side of communication. As a result, communication performance is enhanced.

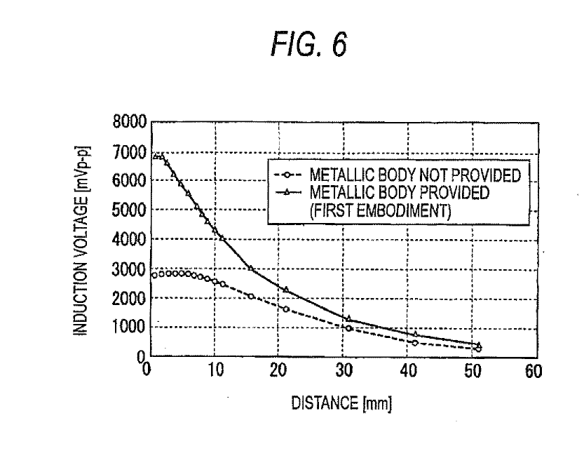

FIG. 6 shows a test result yielded when the antenna 1 of the present invention is compared with an antenna that does not use the metallic body 7. Requirements for measurement are as follows. First, the antenna 1 of the present invention is placed upside down, and input impedance of the input-output terminals 5 and 6 is matched to 50Ω by way of a matching circuit. Subsequently, a signal of 20 dBm is input from a signal generator. The metallic body 7 measures 62 mm×38 mm, and an outer shape of the antenna pattern 3 measures 20 mm×20 mm.

A one-turn search coil measuring 72 mm×42 mm is placed above the antenna 1, and both ends of the search coil are connected to observation terminals of an oscilloscope, thereby carrying out observations at a port impedance of 1 MΩ. The magnetic field developed from the antenna 1 performs cross linkage with respect to the search coil, whereupon an induced voltage occurs at both ends of the search coil. The induced voltage is observed by means of the oscilloscope. The search coil is disposed in such a way that a center of the metallic body 7 of the antenna 1 faces up to a center of the search coil.

When the metallic body 7 is not used, the center of the antenna pattern 3 is arranged so as to face up to the center of the search coil. A horizontal axis shown in FIG. 6 represents a distance between the antenna 1 and the search coil, whilst a vertical axis of the same drawing represents a peak-to-peak voltage of a voltage waveform observed by the oscilloscope. The graph shown in FIG. 6 shows that, when compared with an antenna that does not use the metallic body 7, the antenna 1 of the present invention can cause a greater induced voltage, and it is possible to ascertain a greater effect particularly within a neighborhood of 20 mm.

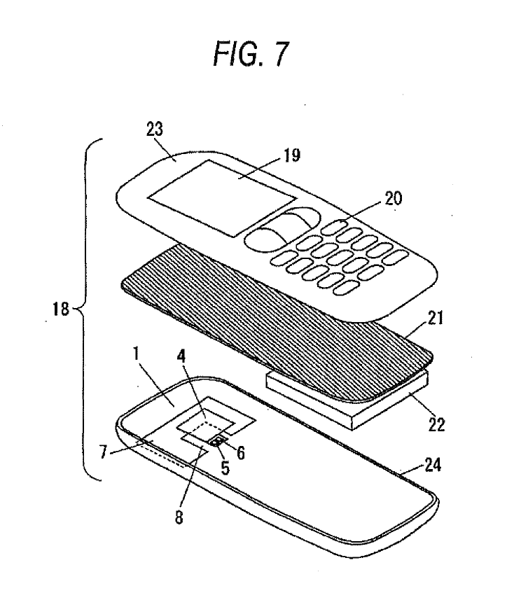

FIG. 7 is an exploded perspective view of a portable terminal using the antenna of the first embodiment of the present invention (a portable phone in the embodiment). A portable terminal 18 is built from a liquid crystal panel 19, buttons 20, and a board 21 and a battery 22 encapsulated between enclosures 23 and 24. The antenna 1 is attached to the enclosure 24. The antenna 1 is attached to the other side of the board 21 where the liquid crystal panel 19 is not disposed. The metallic body 7 is attached to the enclosure 24, and the antenna pattern 3 and the magnetic sheet 4 are piled on the enclosure 24.

Although the metallic body 7 does not need to be attached to the enclosure 24, the characteristic of the antenna will be deteriorated when metallic components mounted on the metallic body 7 and metallic components mounted on the board 21 approach each other. Therefore, it is desirable to keep the metallic components mounted on the metallic body as far away as possible from the metallic components mounted on the board 21.

The enclosure 24 and the metallic body 7 can also be integrated together. Any material may be employed for the enclosure 24 in the case, so long as the material exhibits conductivity in the same manner as does the metallic body 7. The material is selected as appropriate from a conductive metallic plate material, and a conductive metallic foil material, like gold, silver, copper, aluminum, and nickel. The enclosure can be formed from a metallic foil, a conductive paste, transfer plating, sputtering, deposition, or screen printing.

The board 21 can also be used in place of the metallic body 7. In such a case, the antenna is disposed on the other side of the board 21 where the liquid crystal panel is not disposed. From the structural viewpoint, the magnetic sheet 4 and the antenna pattern 3 are provided on the underside of the board 21 in sequence from the board.

Moreover, in the present embodiment, the metallic body 7 is formed from a metallic foil, or the like. Therefore, for instance, a notch is formed in the metallic body 7 in accordance with a layout of components in a portable terminal into which the antenna is to be incorporated, such as a camera, so that the metallic body can be arranged so as to avoid the layout of the components.

A foldable material, such as a metallic foil, is utilized for the metallic body 7 as mentioned above, or the metallic body is formed directly on a curved surface of an enclosure by means of sputtering, or the like. Thus, the metallic body 7 can be placed along the curved surface of the enclosure. Thus, as compared with a related art antenna that cannot be disposed on a curved surface, the antenna can be freely designed.

### Second Embodiment

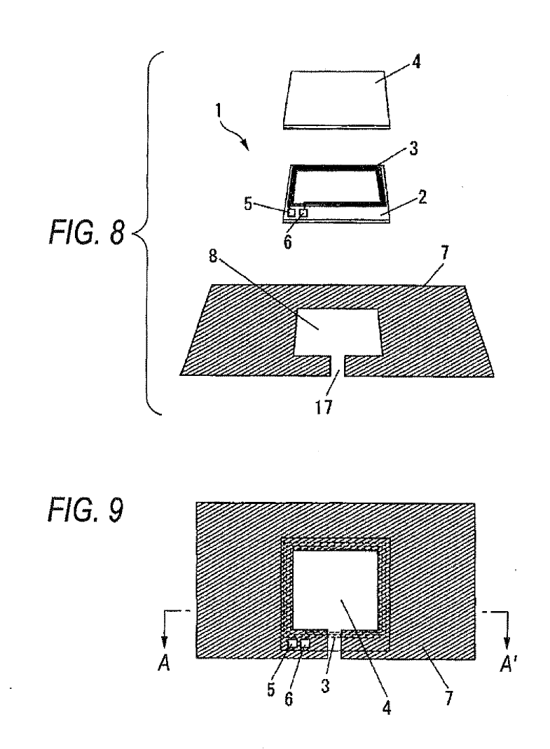

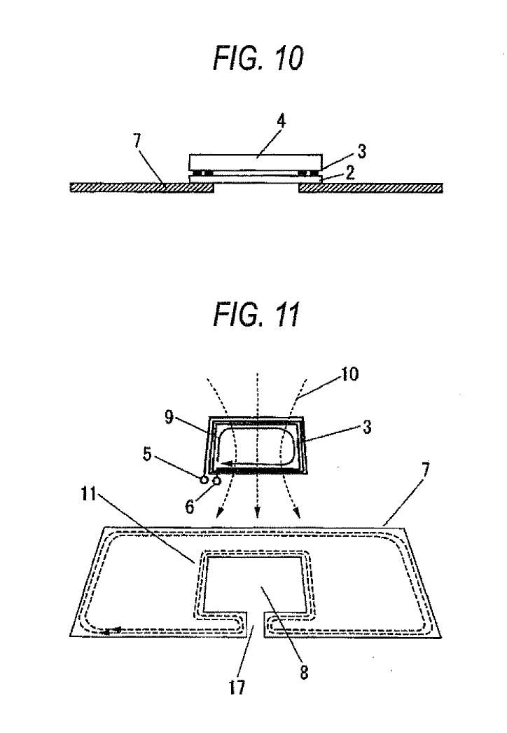

FIG. 8 is an oblique perspective view of the antenna 1 of a second embodiment of the present invention. FIG. 9 is a plan view of the antenna of the second embodiment of the present invention. FIG. 10 is a side view of the antenna of the second embodiment of the present invention.

In the antenna 1 shown in FIG. 8, the loop-shaped antenna pattern 3 is formed on the antenna board 2. FIG. 8 illustrates a case where the antenna pattern 3 has three turns. However, the number of turns of the antenna pattern is not limited to three. In order to lessen influence generated when metal is placed on the antenna, the magnetic sheet 4 is placed on the antenna pattern 3. The antenna pattern 3 is connected to an input-output terminal of a matching circuit and an input-output terminal of an IC by means of the input-output terminals 5 and 6. The metallic body 7 is positioned substantially in contact with the antenna board. The notch 8 of the metallic body 7 is cut out along the aperture of the antenna pattern 3 achieved when the antenna pattern 3 is placed at a center of the metallic body 7. The metallic body 7 is laid out in a geometry in which a slit 17 is formed so as to extend from one side of the notch 8 to an opposing side of the metallic body 7. The configuration of the antenna 1 is analogous to the first embodiment of the present invention.

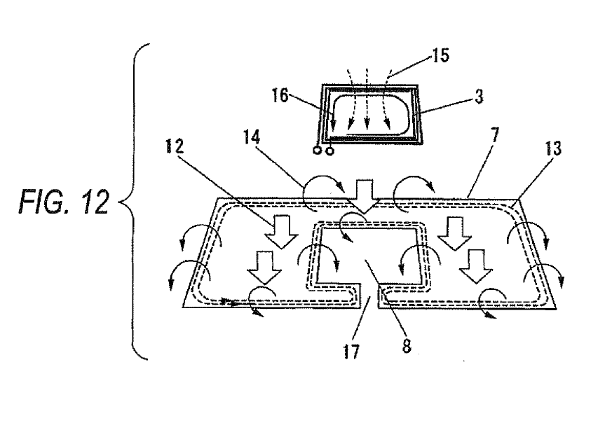

A concept of operation of the antenna of the present invention is now described by reference to FIGS. 11 and 12.

FIG. 11 is a conceptual rendering of the present invention achieved when transmission is performed by means of the antenna. By virtue of the signals entered the input-output terminals 5 and 6 from the outside circuit, the electric current 9 flows into the antenna pattern 3, whereby the magnetic field 10 develops. Although the eddy current 11 develops in the metallic body 7 in a direction cancelling the magnetic field 10, the notch 8 and the slit 17 are provided in the metallic body 7 in such a way that the notch 8 runs along the aperture of the antenna pattern 3 and that the slit 17 extends from one side of the notch 8 to the periphery of the metallic body 7. As a result, the eddy current 11 that is oriented in a direction opposite to the electric current 9 flowing through the antenna pattern 3 flows through the respective sides of the notch. However, the eddy current 11 flowing through the respective sides of the notch are guided to the periphery of the metallic body 7 by the slit 17. Therefore, the eddy current 11 flowing through the periphery of the metallic body 7 is oriented in a forward direction with respect to the electric current 9 flowing through the antenna pattern 3. For these reasons, the antenna pattern apparently becomes larger, so that a degree of coupling with a card that is on the other end of communication becomes greater. As a consequence, communication performance is enhanced.

FIG. 12 is a conceptual rendering of the present invention achieved when the antenna receives a magnetic field from the outside. By virtue of the magnetic field 12 from the outside, the eddy current 13 flows along the periphery of the metallic body 7, and the eddy current 13 causes the magnetic field 14 to develop in the periphery of the metallic body 7. The notch 8 and the slit 17 are provided in the metallic body 7 in such a way that the notch 8 runs along the aperture of the antenna pattern 3 and that the slit 17 extends from one side of the notch 8 to the periphery of the metallic body 7. As a result, the magnetic field 14, such as that shown in FIG. 12, develops in the periphery made up of the respective sides of the notch 8. Consequently, the downwardly oriented magnetic field 15, such as that shown in FIG. 12, develops in an inner periphery of the antenna pattern 3. The eddy current 16 develops in the antenna pattern 3 in a direction cancelling the magnetic field 15. However, the eddy current 16 is oriented in a forward direction with respect to the eddy current 13 flowing through the periphery of the metallic body 7. For these reasons, the antenna pattern apparently becomes larger, to thus become possible to receive a larger amount of magnetic field emitted from the reader/writer that becomes the other end of communication. As a consequence, communication performance is enhanced.

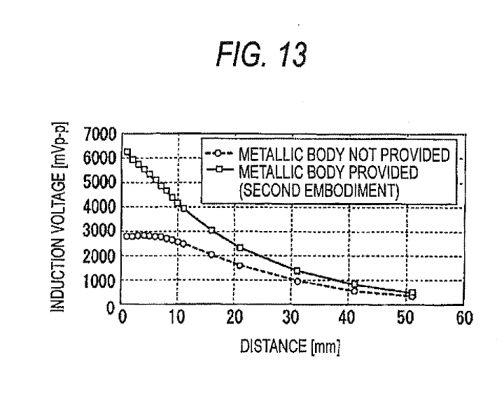

FIG. 13 is a test result achieved when the antenna 1 of the present invention is compare with the antenna that does not use the metallic body 7. Measurement requirements are analogous to those described in connection with the first embodiment of the present invention. According to a graph shown in FIG. 13, the antenna 1 of the present invention can produce a greater induced voltage than does the antenna that does not use the metallic body 7. A greater effect can be ascertained particularly within a neighborhood of 20 mm.

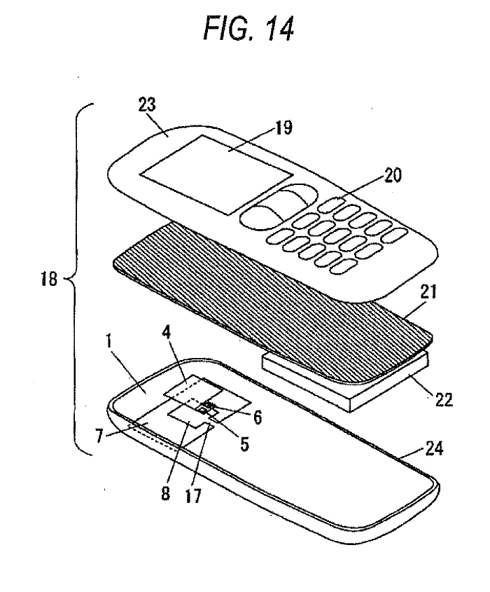

FIG. 14 is an exploded oblique view of a portable terminal using the antenna of the second embodiment of the present invention. The portable terminal 18 and the antenna 1 are structurally analogous to their counterparts described in connection with the first embodiment. It is desirable that the antenna pattern 3 be placed at the center of the metallic body 7. Even in this case, the metallic body 7 does not need to be affixed to the enclosure 24. However, when metallic components mounted on the metallic body 7 and metallic components mounted on the board 21 come close to each other, a characteristic of the antenna is deteriorated. For this reason, it is desirable to keep the metallic components mounted on the metallic body 7 as far away as possible from the metallic components mounted on the board 21.

In FIG. 1, the notch 8 is formed so as to run along three sides of the aperture of the antenna pattern 3. However, the notch 8 may also be formed so as to run along two sides of the aperture of the antenna pattern 3.

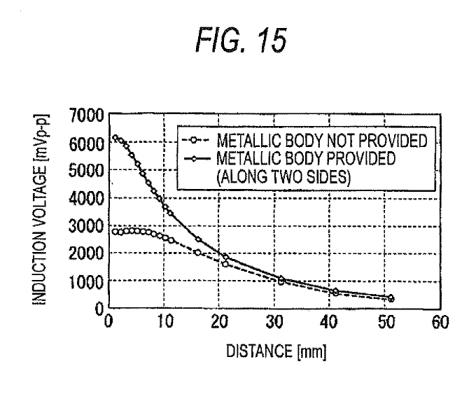

FIG. 15 shows a test result of a comparison between the antenna 1 including the notch 8 of the metallic body 7 that is aligned with two sides of the aperture of the antenna pattern 3 and the antenna that does not use the metallic body 7. According to the graph shown in FIG. 15, even when the notch is aligned with two sides of the aperture of the antenna pattern 3, the antenna 1 of the present invention can produce a greater induced voltage than does the antenna that does not use the metallic body 7.

As mentioned above, the antenna of the present invention includes the followings; namely, a loop antenna having an aperture, a metallic body that opposes the loop antenna and that is electrically insulated from the loop antenna; and a notch that is provided in the metallic body and that is coupled with the periphery of the metallic body. At least a portion of the loop antenna opposes the metallic body, and at least a portion of the notch is covered with the aperture. An air field in a communicable area is reduced while the communicable area is being expanded. Therefore, it is possible to provide an antenna that exhibits superior communication performance within the communicable area.

As a result of the metallic body being disposed on the side where the aperture of the loop antenna exits, an eddy current flowing through the metallic body becomes likely to develop, and much superior communication performance can be exhibited within the communicable area.

An outer shape of the loop antenna is smaller than the metallic body, and the notch is smaller than the outer shape of the loop antenna, so that the loop antenna thoroughly faces the metallic body. Hence, much superior communication performance can be exhibited within the communicable area.

The aperture of the loop antenna is placed on the metallic body so as to cover the entirety of the notch. As a result, the loop antenna thoroughly opposes the metallic body within the greatest area, and hence highly superior communication performance can be exhibited within the communicable area.

Since the notch is substantially equal in size with the aperture of the loop antenna, the loop antenna thoroughly opposes the metallic body, so that the magnetic field passing through the aperture is not blocked by the metallic body. Accordingly, the loop antenna thoroughly opposes the metallic body within the greatest area and hence highly superior communication performance can be exhibited within the communicable area.

The entirety of an end that is an end of the metallic body and that makes up the notch opposes the loop antenna. As a result, the loop antenna opposes the metallic body without fail in the greatest area, and hence very excellent communication performance can be exhibited within the communicable area.

The metallic body includes the notch covered with the aperture of the loop antenna, an opposite direction current generation block that opposes the loop antenna, and a non-opposing block that does not opposes the antenna. As a result, the communicable area can be expanded without fail. Since the air field in the communicable area is reduced, there can be provided an antenna that efficiently exhibits superior communication performance within the communicable area.

Further, an electric current flowing through the opposite direction current generation block is opposite in direction to an electric current flowing through the loop antenna. An electric current flowing through the non-opposing block is identical in direction with the electric current flowing through the loop antenna. The communicable area is thereby expanded without fail. Moreover, since the air field in the communicable area is reduced, there can be provided an antenna that efficiently exhibits superior communication performance within the communicable area.

A magnetic field caused by the electric current flowing through the opposite direction current generation block is opposite in direction to a magnetic field caused by the electric current flowing through the loop antenna. A magnetic field caused by the electric current flowing through the non-opposing block is identical in direction to the magnetic field caused by the electric current flowing through the loop antenna. The communicable area can thereby be expanded reliably. Further, the air field in the communicable area is reduced, and hence there can be provided an electronic device that efficiently exhibits superior communication performance within the communicable area.

The entire aperture of the loop antenna is situated within the notch, whereby a magnetic field passing through the aperture is not blocked by the metallic body. Accordingly, the loop antenna thoroughly opposes the metallic body within the largest area, and hence much superior communication performance can be exhibited within the communicable area.

The antenna of the present invention has the followings; namely, a loop antenna having an aperture, a metallic body that is electrically insulated from the loop antenna and that is placed on a side where the aperture of the loop antenna is provided; and a notch that is smaller than the outer shape of the loop antenna, that is provided in the metallic body, and that is coupled with a periphery of the metallic body. The loop antenna is placed on the metallic body so as to cover the notch. The air field within the communicable area is thereby reduced while the communicable area is being expanded, and hence there can be provided an antenna that exhibits superior communication performance within a communicable area.

Further, as a result of the antenna being disposed in the enclosures and the metallic body being provided on the back side of the enclosure, the air field within the communicable area is reduced while the communicable area is being expanded. Hence, there can be provided an antenna that exhibits superior communication performance within the communicable area.

The antenna is disposed within the enclosures, and a circuit board disposed within the enclosures is used as a metallic body. The air field within the communicable area is thereby reduced while the communicable area is being expanded, and hence there can be provided an electronic device that exhibits superior communication performance within the communicable area. Further, further miniaturization of the antenna can be pursued.

The antenna of the present invention and the portable terminal using the same exhibit superior communication performance within a communicable area while expanding the communicable area and hence are useful for an electronic device, like a portable phone.

This application claims the benefit of Japanese Patent application No. 2010-060617 filed on Mar. 17, 2010, the entire contents of which are incorporated herein by reference.

What is claimed is:

1. An antenna comprising:
a loop antenna having an aperture;
a metallic body that opposes the loop antenna and that is electrically insulated from the loop antenna; and
a notch that is provided in the metallic body and that is coupled with a periphery of the metallic body, wherein
at least a portion of the loop antenna opposes the metallic body, and at least a portion of the notch is covered with the aperture.

2. The antenna according to claim 1, wherein the metallic body is disposed on a side where the aperture of the loop antenna is provided.

3. The antenna according to claim 1, wherein an outer shape of the loop antenna is smaller than the metallic body, and wherein the notch is smaller than the outer shape of the loop antenna.

4. The antenna according to claim 3, wherein the aperture of the loop antenna is placed on the metallic body so as to cover the entirety of the notch.

5. The antenna according to claim 1, wherein the notch is substantially equal in size to the aperture of the loop antenna.

6. The antenna according to claim 4, wherein an entirety of an end that is an end of the metallic body and forms the notch opposes the loop antenna.

7. The antenna according to claim 1, wherein the metallic body includes the notch covered with the aperture of the loop antenna, an opposite direction current generation block that opposes the loop antenna, and a non-opposing block that does not oppose the antenna.

8. The antenna according to claim 7, wherein an electric current flowing through the opposite direction current generation block is opposite in direction to an electric current flowing through the loop antenna, and an electric current flowing through the non-opposing block is identical in direction with the electric current flowing through the loop antenna.

9. The antenna according to claim 7, wherein a magnetic field induced by an electric current flowing through the opposite direction current generation block is opposite in direction to a magnetic field induced by an electric current flowing through the loop antenna; and wherein
a magnetic field induced by an electric current flowing through the non-opposing block is identical in direction with the magnetic field induced by the electric current flowing through the loop antenna.

10. The antenna according to claim 1, wherein an entirety of the aperture of the loop antenna is situated within the notch.

11. An antenna comprising:
a loop antenna having an aperture;
a metallic body that is electrically insulated from the loop antenna and that is disposed on a side where the aperture of the loop antenna is provided; and
a notch that is provided in the metallic body, that is smaller than an outer shape of the loop antenna, and that is coupled with a periphery of the metallic body, wherein
the loop antenna is provided on the metallic body so as to cover the notch.

12. A portable terminal that includes the antenna of claim 1 provided within enclosures and the metallic body disposed on a back side of one of the enclosures.

13. A portable terminal that includes the antenna of claim 1 provided within enclosures and that uses as a metallic body a circuit board disposed within the enclosures.
